(19) United States
(12) Patent Application Publication
(10) Pub. No.: US 2026/0285671 A1
(43) Pub. Date: Sep. 24, 2026

(54) HORSE RIDING SADDLE PAD

(71) Applicant: AMAHORSE GROUP S.P.A., San Giustino (Perugia) (IT)

(72) Inventor: Riccardo VOLPI, San Giustino (Perugia) (IT)

(21) Appl. No.: 19/567,432

(22) Filed: Mar. 16, 2026

(30) Foreign Application Priority Data
Mar. 20, 2025 (IT) 102025000005706

(51) Int. Cl. B68C 1/12

(52) U.S. Cl. CPC B68C 1/12

(57) ABSTRACT

A horse riding saddle pad has a saddle pad body formed of a polymeric foam. The saddle pad body has at least one cushion portion, and on an upper side and/or on a lower side of the at least one cushion portion, a plurality of mutually parallel straight grooves is formed. At least some of the mutually parallel straight grooves have a depth such as to allow the at least one cushion portion to bend and/or twist to allow the saddle pad body to adapt to a shape of a horse.

### CROSS REFERENCE TO RELATED APPLICATION

This application claims priority to and benefit of Italian Patent Application No. 102025000005706 filed Mar. 20, 2025, the contents of which are incorporated by reference in their entirety.

### FIELD OF THE INVENTION

The present invention relates to the field of equestrian sports equipment. In particular, the present invention relates to a horse riding saddle pad.

### BACKGROUND OF THE INVENTION

It is known to interpose a saddle pad between the horse's back and the saddle to protect the horse's back and improve the rider's comfort.

For example, saddle pads made of gel or polyurethane foam are known. Polyurethane foam saddle pads are highly appreciated because they make it possible to achieve zones of elevated thickness for damping impacts between rider and horse, in particular in some disciplines, such as jumping and dressage.

However, the need is increasingly felt to combine high comfort for the rider with high sporting performance, improving the connection between horse and rider, despite the presence of a saddle pad.

A further aspect to be considered in the use of such saddle pads is the excessive sweating of the horse. It is thus desirable to provide an adequate passage of air between the horse's back and the saddle pad.

### SUMMARY OF THE INVENTION

Therefore, it is the object of the present invention to provide a horse riding saddle pad capable of meeting the above-mentioned requirements.

This object is achieved by a horse riding saddle pad as described and claimed herein.

### BRIEF DESCRIPTION OF THE DRAWINGS

Further features and advantages of the saddle pad according to the present invention will become apparent from the following description of some preferred exemplary embodiments, given by way of indicative and non-limiting examples, with reference to the accompanying drawings, in which:

FIG. 1 shows a side view of a horse riding saddle pad in an embodiment, according to the present invention;

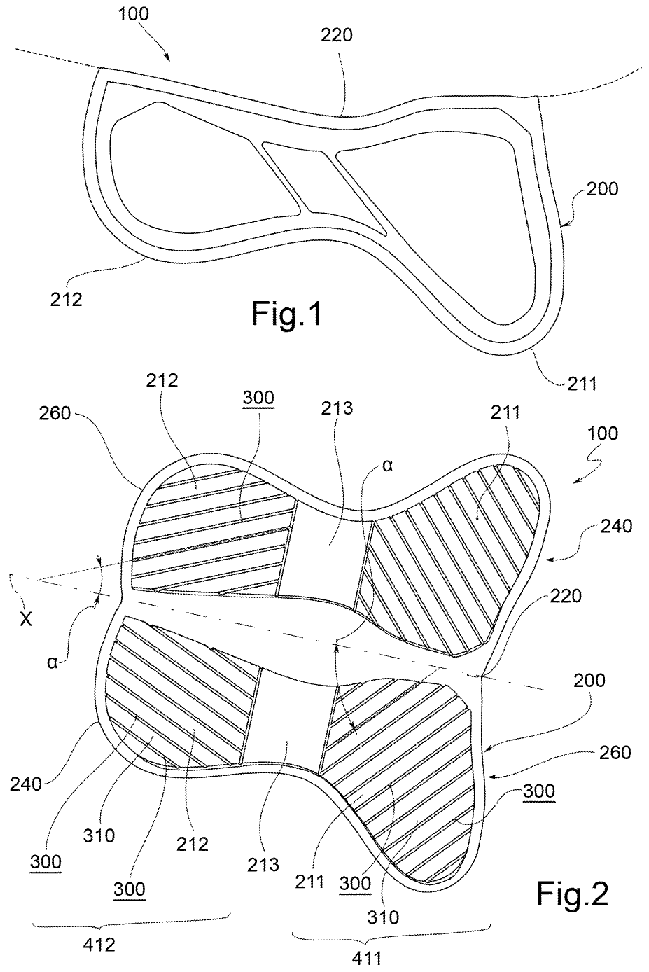

FIGS. 2, 3 and 4 are inner side views, i.e., facing the horse's back, of a saddle pad according to the present invention, in as many alternative embodiments; and

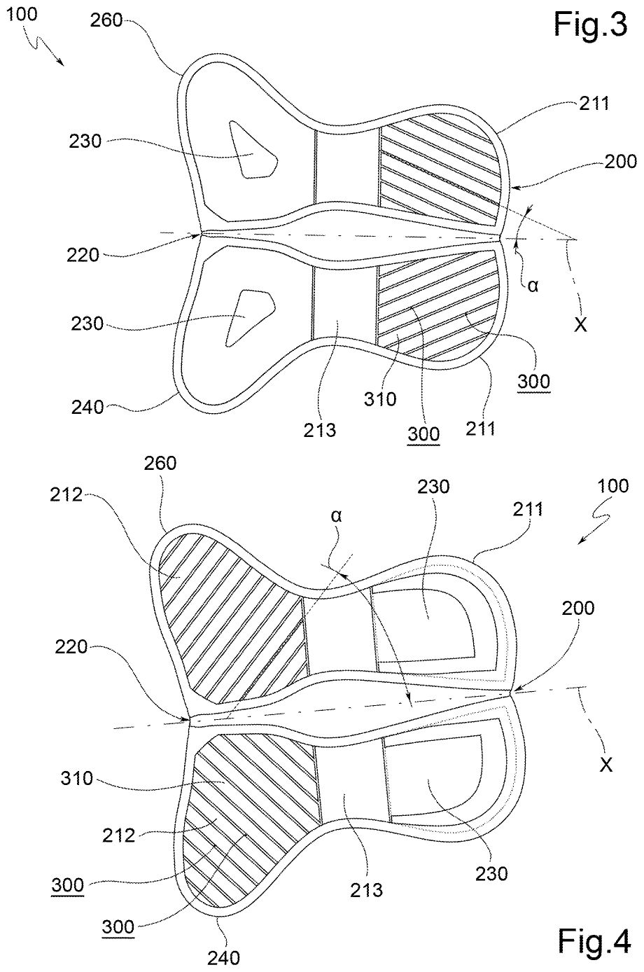

FIG. 5 is a section view of a portion of a saddle pad according to the present invention.

### DETAILED DESCRIPTION

In the following description, all directional references (e.g., top, bottom, front, rear, up, down, left, right, towards left, towards right, at the top, at the bottom, top, bottom, vertical, horizontal, clockwise, and counterclockwise) are used only for identification purposes to help the reader understand the described embodiments and do not create any limitations, in particular regarding the location, orientation, or use of the described embodiments.

With reference to the figures, reference numeral 100 indicates a horse riding saddle pad as a whole.

The horse riding saddle pad 100 comprises a saddle pad body 200 formed essentially of a polymeric foam.

Polymeric foams (or polymeric expanded materials) mean materials composed of a solid polymeric matrix and of a gaseous phase dispersed in the form of cells or pores. In particular, polymeric foams may have a cellular structure, the cells of which may be closed or open, which gives extreme lightness with respect to the compact material from which they are derived.

The polymeric foam may be, for example, a polyurethane foam, a polyethylene foam, a latex foam, an Ethylene Vinyl Acetate (EVA) foam.

In an embodiment, the polymeric foam of the saddle pad body 200 is, for example, a polyurethane foam, preferably an open-cell polyurethane foam.

In an embodiment, the polymeric foam of the saddle pad body 200 has a density comprised between 80 kg/m³ and 110 kg/m³, preferably comprised between 90 kg/m³ and 95 kg/m³.

In an embodiment, the saddle pad body 200 comprises a lower layer 410, i.e., suitable for facing the horse's back, of polyester fabric which covers the polymeric foam. Advantageously, the lower layer 410 made of polyester fabric gives greater breathability between the saddle pad and the horse.

In an embodiment, the saddle pad body 200 comprises a support layer 420 made of fabric, preferably a three-dimensional fabric (also known as “3D fabric”), above the polymeric foam. Advantageously, the support layer 420 facilitates the formation of the polymeric foam in the mold during molding and protects it from contact with the saddle in use.

The saddle pad body 200 comprises at least one cushion portion 211; 212. The at least one cushion portion 211; 212 has a substantially planar extension, i.e., it has a thickness S1 (defined as the distance between its upper side 201, i.e., which, in use, is facing the saddle, and its lower side 202, i.e., which, in use, is facing the horse's back), which is substantially constant.

On the upper side 201 and/or on the lower side 202 of the at least one cushion portion 211; 212 a plurality of grooves 300 is formed.

In an embodiment, the grooves 300 are mutually straight and parallel.

For example, the grooves 300 are obtained by compressing the polymeric foam locally, i.e., along straight directions.

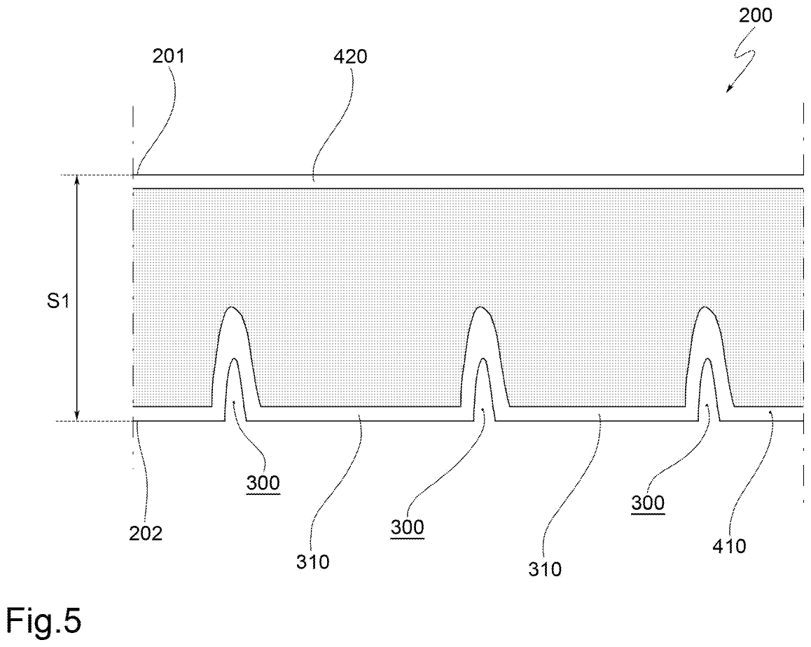

In an embodiment, shown for example in FIG. 5, the plurality of grooves 300 is formed in the lower side of the cushion portion 211; 212.

In a further embodiment, when the grooves 300 are formed both on the lower side 202 and on the upper side 201 of the cushion portion 211; 212, the grooves 300 formed in one side are offset with respect to the grooves formed in the opposite side, so as not to weaken the saddle pad body 200 excessively.

According to the present invention, at least some of the grooves 300, preferably all, have a depth such as to allow the cushion portion 211; 212 to bend and/or twist. Thereby, the horse riding saddle pad 100 adapts even better to the shape of the horse both static and dynamic, i.e., while riding.

In other words, at least some grooves 300 behave as fold lines which divide the cushion portion 211; 212 into adjacent sections 310. The fold lines connect the adjacent sections 310 in a hinge-like or joint-like manner, allowing their relative movement.

Advantageously, the presence of the grooves 300 gives the horse riding saddle pad the possibility to accommodate possible torsions, bends and twists resulting from the horse's physical shape and movement dynamics.

Furthermore, the grooves 300 also function as channels or passages for air, allowing greater breathability and reducing friction between the horse's back and the saddle pad.

Additionally, the grooves 300 make it possible to optimize the ventilation and thermal management between the horse's back and the saddle. In particular, the grooves promote an effective air recirculation, reducing the accumulation of heat and humidity in the dorsal area. This configuration contributes to improving the breathability of the saddle pad, preventing overheating, minimizing the risk of skin irritations or localized pressures on the horse and preserving the integrity of the horse's coat, ensuring greater comfort in use.

In an embodiment, the thickness S1 of the cushion portion 211; 212 is comprised between 13 mm and 20 mm, preferably between 15 mm and 18 mm, e.g., equal to 16 mm.

In an embodiment, the grooves 300 have a depth less than half of the thickness S1 of the cushion portion, preferably less than one third of the thickness S1.

In an embodiment, the grooves 300 have a depth equal to 5 mm.

In an embodiment, the plurality of grooves 300 extends substantially over the entire planar extension of the cushion portion 211; 212.

In an embodiment, the saddle pad body 200 comprises a central portion 220, which extends along a longitudinal body axis X and which is suitable for being positioned on the horse's vertebral column, and two lateral portions 240, 260. The two lateral portions 240, 260 extend symmetrically from the central portion 220. Each lateral portion 240, 260 comprises at least one cushion portion 211; 212.

In an embodiment, the two lateral portions 240, 260 have the same shape, substantially planar extension, and are mirror-symmetric with respect to the central portion 220.

In an embodiment, the grooves 300 of the cushion portion 211; 212 form a groove angle α with respect to the longitudinal body axis X. Preferably, the width of the groove angle α is between 30° and 80°, more preferably between 45° and 65°, even more preferably between 50° and 55°.

In an embodiment, each lateral portion 240, 260 comprises a front portion 411 and a rear portion 412. In the present disclosure, front portion means the portion which faces the horse's muzzle in use, while rear portion means the portion which faces the horse's tail in use.

According to the present invention, at least one of the front portion 411 and the rear portion 412 is a cushion portion 211; 212 having the plurality of grooves 300.

In an embodiment, the front portion 411 is a cushion portion 211 having the plurality of grooves 300.

In an embodiment, the rear portion 412 is a cushion portion 212 having the plurality of grooves 300.

In an embodiment, both the front portion 411 and the rear portion 412 are cushion portions 211; 212 having the plurality of grooves 300. In this case, the groove angle α of the grooves 300 of the front cushion portion 211 is opposite to the groove angle α of the grooves 300 of the rear cushion portion 212. In other words, the grooves 300 of the front cushion portion 211 have an opposite and incident inclination with respect to the grooves 300 of the rear cushion portion 212.

In an embodiment, the grooves 300 of the front cushion portion 211 have a different inclination and incident direction with respect to the grooves 300 of the rear cushion portion 212.

In a further embodiment, the grooves 300 of the front cushion portion 211 have the same inclination and incident direction with respect to the grooves 300 of the rear cushion portion 212.

In an embodiment, the front portion 411 and the rear portion 412 are separated from each other by a transverse central portion 213 without grooves.

In an embodiment, one of the front portion 411 and the rear portion 412 is a cushion portion 211; 212 having the plurality of grooves 300 and the other of the front portion 411 and the rear portion 412 has a raised central region 230 having a greater thickness than the thickness of the cushion portion 211; 212.

In an embodiment, the front portion 411 is a cushion portion 211 having the plurality of grooves 300, and the rear portion 412 has the raised central region 230.

In an embodiment, the rear portion 412 is a cushion portion 212 having the plurality of grooves 300, and the front portion 411 displays the raised central region 230.

The raised central region 230 makes it possible to compensate and/or correct any misalignments or anatomical differences in the horse's back or in areas of the horse's conformation which may not correspond to the ideal shape of a horse's back. Therefore, the presence of the raised central region advantageously makes it possible to improve the adaptation of the saddle pad to the horse's specific morphology, distributing the pressure more uniformly and ensuring optimal comfort during the activity.

According to a further advantage, the raised central region 230 allows the saddle pad to further absorb the stresses to which the rider and the horse are subjected, in particular in some disciplines such as show jumping and dressage.

In an embodiment, the raised central region 230 has a thickness comprised between 26 mm and 50 mm, preferably comprised between 30 mm and 42 mm, e.g., equal to 32 mm or equal to 40 mm.

The horse riding saddle pad according to the present invention is adaptable to the horse's physical shape and movement dynamics. In particular, the presence of grooves allows the saddle pad to accommodate possible torsions, bends, and twists.

Therefore, the horse riding saddle pad is particularly ergonomic and contributes to increasing the sense of connection between the horse and the rider.

According to a further advantage, the grooves permit the passage of an air flow between the saddle pad and the horse, increasing breathability and reducing friction between the horse's back and the saddle pad.

Advantageously, the presence of a front or rear portion of increased height enables the saddle pad to compensate and/or correct any misalignments or anatomical differences in the horse's back.

It is apparent that, with respect to the embodiments of the aforesaid horse riding saddle pad, a person skilled in the art, to satisfy specific requirements, may make modifications or substitutions of elements with other functionally equivalent ones. Such variants are also contained in the scope of protection as defined by the following claims. Furthermore, each variant described as belonging to a possible embodiment may be implemented independently from the other described variants.

What is claimed is

1. A horse riding saddle pad comprising a saddle pad body formed of a polymeric foam, the saddle pad body comprising at least one cushion portion, wherein in an upper side and/or in a lower side of the at least one cushion portion a plurality of mutually parallel straight grooves is formed, and wherein at least some of the mutually parallel straight grooves have a depth such as to allow the at least one cushion portion to bend and/or twist to allow the saddle pad body to adapt to a shape of a horse.

2. The horse riding saddle pad of claim 1, wherein the plurality of mutually parallel straight grooves extends over an entire planar extension of the at least one cushion portion.

3. The horse riding saddle pad of claim 1, wherein the saddle pad body comprises a central portion suitable for being positioned on a vertebral column of the horse and two lateral portions extending symmetrically from the central portion,
wherein the central portion extends along a longitudinal body axis,
wherein each groove of the plurality of mutually parallel straight grooves of the at least one cushion portion forms a groove angle with respect to the longitudinal body axis, and
wherein a width of the groove angle is between 30° and 80°.

4. The horse riding saddle pad of claim 3, wherein the width of the groove angle is between 45° and 65°.

5. The horse riding saddle pad of claim 3, wherein the width of the groove angle is between 50° and 55°.

6. The horse riding saddle pad of claim 3, wherein each of the two lateral portions comprises a front cushion portion and a rear cushion portion, wherein the plurality of mutually parallel straight grooves is formed in both the front and rear cushion portions, and wherein the groove angle of the mutually parallel straight grooves of the front cushion portion is opposite to the groove angle of the mutually parallel straight grooves of the rear cushion portion.

7. The horse riding saddle pad of claim 6, wherein the front cushion portion and the rear cushion portion are separated from each other by a transverse central portion without grooves.

8. The horse riding saddle pad of claim 1, wherein the at least one cushion portion has a substantially constant thickness defined by a distance between the upper side and the lower side of the at least one cushion portion, and wherein the mutually parallel straight grooves have a depth of less than half of the thickness of the at least one cushion portion.

9. The horse riding saddle pad of claim 8, wherein the mutually parallel straight grooves have a depth of less than a third of the thickness of the at least one cushion portion.

10. The horse riding saddle pad of claim 1, wherein the saddle pad body comprises a lower layer made of a polyester fabric that covers the polymeric foam.

11. The horse riding saddle pad of claim 1, wherein the saddle pad body comprises, above the polymeric foam, a support layer made of a three-dimensional fabric.

12. The horse riding saddle pad of claim 8, wherein the saddle pad body comprises a front portion, a transverse central portion, and a rear portion, wherein one of the front portion and the rear portion is a cushion portion having the plurality of mutually parallel straight grooves, and wherein the other of the front portion and the rear portion has a raised central region having a greater thickness than the thickness of the at least one cushion portion.

13. The horse riding saddle pad of claim 1, wherein the polymeric foam is a polyurethane foam.

14. The horse riding saddle pad of claim 1, wherein the polymeric foam is an open-cell polyurethane foam.

15. The horse riding saddle pad of claim 1, wherein the polymeric foam of the saddle pad body has a density between 80 kg/m³ and 110 kg/m³.

16. The horse riding saddle pad of claim 1, wherein the polymeric foam of the saddle pad body has a density between 90 kg/m³ and 95 kg/m³.
